(19) United States
(12) Patent Application Publication
(10) Pub. No.: US 2004/0228491 A1
(43) Pub. Date: Nov. 18, 2004

(54) CIPHERING ACTIVATION DURING AN INTER-RAT HANDOVER PROCEDURE

(76) Inventor: Chih-Hsiang Wu, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,851

(22) Filed: May 13, 2003

(51) Int. Cl. H04K 1/00

(52) U.S. Cl. 380/272; 380/247

(57) ABSTRACT

A HANDOVER FROM UTRAN procedure is performed to handover a wireless device from the UTRAN to a second network. While attached to the second network, the wireless device sends an INTER RAT HANDOVER INFO message to the UTRAN. The INTER RAT HANDOVER INFO message includes the security START value maintained by the wireless device for ciphering purposes. In response to determining that the security START value equals or exceeds a THRESHOLD value, the UTRAN disables ciphering with the wireless device when performing a HANDOVER TO UTRAN procedure. Similarly, the wireless device disables ciphering when performing the HANDOVER TO UTRAN procedure if the START value equals or exceeds the THRESHOLD value. Alternatively, a new ciphering key set is generated while the wireless device is attached to the second network, and ciphering is performed during the HANDOVER TO UTRAN procedure, utilizing the new key set.

### BACKGROUND OF INVENTION

1. Field of the Invention

The present invention relates to wireless communications. More particularly, the present invention relates to the handling of security services in a 3GPP system when performing an Inter-RAT handover procedure.

2. Description of the Prior Art

The 3^{rd} Generation Partnership Project (3GPP) specifications 3GPP TS 25.331 V3.13.0 (2002-12) “Radio Resource Control (RRC) Protocol Specification” and 3GPP TS 33.102 V3.12.0 (2002-06) “Security architecture”, both of which are included herein by reference, provide technical description of a Universal Mobile Telecommunications System (UMTS), and related security protocols thereof. The UMTS discloses a device (typically a mobile device), termed user equipment (UE), in wireless communications with one or more base stations. These base stations (so-called Node Bs), with their corresponding Radio Network Controllers (RNCs), are collectively termed the UMTS Terrestrial Radio Access Network, or UTRAN for short. In general, from the standpoint of security, peer entity radio resource control (RRC) layers on the UE and UTRAN sides establish one or more radio access links with each other to exchange signaling and user data by way of RRC protocol data units (PDUs). In the following brief background, which is taken from the above-indicated document 3GPP TS 33.102, familiarity with 3GPP protocols is assumed.

Please refer to FIG. 1. FIG. 1 illustrates the use of integrity algorithm f9 to authenticate the data integrity of a signaling message. Input parameters into the f9 algorithm include an Integrity Key (IK), an integrity sequence number (COUNTa random value generated on the network side (FRESH), a direction bit DIRECTION, and finally the signaling message data MESSAGE held within the RRC PDU. Based upon these input parameters, the wireless equipment computes an authentication code MAC-I for data integrity verification, by way of the integrity algorithm The MAC-I code is then appended to the corresponding signaling message when sent over the radio access link. A receiver computes XMAC-I from the received signaling message in the same manner as the sender computed the equivalent MAC-I on the sent signaling message, and verifies the data integrity of the received signaling message by comparing the receiver-side computed XMAC-I code to the received MAC-I code.

Please refer to FIG. 2. FIG. 2 is a block diagram of the data structure of the COUNT-I value depicted in FIG. 1. The integrity sequence number COUNT-I is 32 bits long.COUNT-I is composed of two parts: a “short” sequence number and a “long” sequence number. The “short” sequence number forms the least significant bits of COUNT-I, while the “long” sequence number forms the most significant bits of COUNT-I. The “short” sequence number is a 4-bit RRC sequence number RRC SN that is present in each RRC PDU. The “long” sequence number is a 28-bit RRC hyper frame number RRC HFN, which is incremented at each RRC SN cycle. That is, upon detection of rollover of the RRC SN within a RRC PDU, the RRC HFN is incremented by the RRC layer. Whereas the RRC SN is transmitted with the RRC PDU, the RRC HFN is not transmitted and is instead maintained by the peer entity RRC layers of the wireless device and the UTRAN.

The RRC HFN is initialised by means of a parameter START, which is described in section of the above-indicated document 3GPP TS 33.102. The UE, and the RNC to which the UE is assigned, then initialise the 20 most significant bits of the RRC HFN to the START value; the remaining bits of the RRC HFN are initialised to 0.

Please refer to FIG. 3. FIG. 3 illustrates the ciphering of user and signalling data over a radio access link. As with integrity checking, the input parameters into a ciphering algorithm f8 are the cipher key CK, a time dependent input COUNT-C, the bearer identity BEARER, the direction of transmission DIRECTION, and a value LENGTH, which is the length of the keystream required. Based on these input parameters the f8 algorithm generates an output keystream KEYSTREAM BLOCK, which is used to encrypt an input plaintext block PLAINTEXT to produce the output ciphertext block CIPHERTEXT. The input parameter LENGTH affects only the length of KEYSTREAM BLOCK, and not the actual bits in KEYSTREAM BLOCK.

The ciphering sequence number COUNT-C is 32 bits long. There is one COUNT-C value per up-link radio bearer and one COUNT-C value per down-link radio bearer in radio link control (RLC) acknowledged mode (AM) or RLC unacknowledged mode (UM) connections. The RLC layer lies below the RRC layer; and may be thought of as a layer-2 interface. For all transparent mode (TM) RLC radio bearers of the same core network (CN) domain, COUNT-C is the same, and COUNT-C is also the same for both the uplink and downlink TM connections.

Please refer to FIG. 4. FIG. 4 is a block diagram of the COUNT-C value of FIG. 3 for all connection modes. COUNT-C is composed of two parts: a “short” sequence number and a “long” sequence number. The “short” sequence number forms the least significant bits of COUNT-C, while the “long” sequence number forms the most significant bits of COUNT-C. The update of COUNT-C depends on the transmission mode as described below: -For RLC TM on a dedicated channel (DCH), the “short” sequence number is the 8-bit connection frame number (CFN) of COUNTIt is independently maintained in the UE MACentity and the serving RNC (SRNC) MAC-d entity. The SRNC is the RNC to which the UE is assigned, and through which the UE communicates with the network. The “long” sequence number is the 24-bit MACHFN, which is incremented at each CFN cycle.

For RLC UM mode, the “short” sequence number is a 7-bit RLC sequence number (RLC SN), which is obtained from the RLC UM PDU header. The “long” sequence number is a 25-bit RLC UM HFN, which is incremented at each RLC SN cycle. RLC HFNs are analogous, in this respect, to RRC HFNs, but are maintained by the RLC layer in the wireless device (both on the UE side and the RNC side).

For RLC AM mode, the “short” sequence number is the 12-bit RLC sequence number (RLC SN) obtained from the RLC AM PDU header. The “long” sequence number is the 20-bit RLC AM HFN, which is incremented at each RLC SN cycle.

The hyperframe numbers (HFNs) above are initialized by means of the parameter START, which is described in section of 3GPP TS 33.102. The UE and the RNC initialize the 20 most significant bits of the RLC AM HFN, RLC UM HFN and MACHFN to START. The remaining bits of the RLC AM HFN, RLC UM HFN and MACHFN are initialized to zero.

Authentication and key agreement, which generates cipher/integrity keys, is not mandatory at call set-up, and there is therefore the possibility of unlimited and malicious re-use of compromised keys. A mechanism is needed to ensure that a particular cipher/integrity key set is not used for an unlimited period of time, to avoid attacks using compromised keys. The USIM, which is nonvolatile memory within the UE, therefore contains a mechanism to limit the amount of data that is protected by an access link key set.

The CN is divided into two distinct and separate domains: a circuit switched (CS) domain, and a packet switched (PS) domain. Each time an RRC connection is released, the values START_{CS} and START_{PS} of the bearers that were protected in that RRC connection are compared with a maximum value THRESHOLD. START_{CS} is the START value used for the CS domain. START_{PS} is the START value used for the PS domain. If START_{CS} and/or START_{PS} have reached or exceeded the maximum value THRESHOLD, the UE marks the START value in the USIM for the corresponding CN domain(s) as invalid by setting the START_{CS} and/or START_{PS} to THRESHOLD. The UE then deletes the cipher key and the integrity key stored in the USIM, and sets the key set identifier (KSI) to invalid (refer to section of 3GPP TS 33.102). Otherwise, the START_{CS} and START PS are stored in the USIM. START value calculation is indicated in section 8.5.9 of 3GPP TS 25.331, and is typically obtained from the most significant bits of the greatest COUNT-C or COUNT-I value within the domain. The maximum value THRESHOLD is set by the operator and stored in the USIM.

When the next RRC connection is established, START values are read from the USIM for the appropriate domain(s). Then, the UE triggers the generation of a new access link key set (a cipher key and an integrity key) if START_{CS} and/or START_{PS} has reached the maximum value, THRESHOLD, for the corresponding core network domain(s).

At radio connection establishment for a particular serving network domain (CS or PS) the UE sends the START_{CS} and the START_{PS} value to the RNC in the RRC connection setup complete message. The UE then marks the START values in the USIM as invalid by setting START_{CS} and START_{PS} to THRESHOLD. The purpose of doing this is to prevent unintentional reuse of START values if the UE should be turned off or otherwise incapacitated before new START values can be written back to the USIM.

In addition to the above, sections 8.3.7, 8.3.9, 8.3.11 and 8.5.2 of 3GPP TS 25.331 also indicate when to store START values in the USIM.

The 3GPP protocol enables a UE to switch over to another wireless protocol, such as a Global System for Mobile Communications (GSM) protocol, which is performed by one of various so-called Inter-Radio access technology (Inter-RAT) procedures. Please refer to FIG. 5. FIG. 5 is a simple block diagram of an Inter-RAT procedure taking place. Initially, a UE 20 has an established RRC connection 21 with a 3GPP UTRAN 10. The RRC connection 21 may be in either the CS domain 12 or the PS domain 14, though typically in any Inter-RAT procedure the RRC connection 21 will be in the CS domain 12, and so this is assumed in the following. As the UE 20 moves closer to the range of a GSM network 30, a decision may be made by the UTRAN 10 to switch the UE 20 over to the GSM network 30. When the Inter-RAT procedure completes successfully, the UE 20 will have established a connection 23 with the GSM network 30. The connection 21 with the UTRAN is subsequently dropped. Consequently, the START value within the UE 20 USIM 20u must be updated. In this example, the START_{CS} value 22 would need to be updated within the USIM 20u. Problems can occur, however, if the START value exceeds the THRESHOLD value during the Inter-RAT handover.

Suppose that the UE 20 is switched on within the UTRAN 10. A UMTS authentication procedure is performed (see section 6.8 of 3GPP TS 33.102 for details) that generates a GSM ciphering key K_{C} 28 from a ciphering key set stored within the USIM 20u, which contains a ciphering key CK_{CS} 24 and an integrity key IK_{CS} 26. The UE 20 initiates a call within the CS domain 12, and ciphering is activated, utilizing the ciphering key CK_{CS} 24 and the integrity key IK_{CS} 26. The UE 20 then begins to move towards the coverage of a base station subsystem (BSS) within the GSM network 30. Based upon signal measurement reports sent by the UE 20, the UTRAN 10 eventually decides to hand over the UE 20 to the GSM network 30. An Inter-RAT handover procedure thus takes place, by way of a HANDOVER FROM UTRAN command sent from the UTRAN 10 to the UE 20. Assume that when this Inter-RAT procedure occurs, the START_{CS} value 22 has reached the THRESHOLD value. Consequently, consistent with the security arrangement discussed above, upon successfully completing the handover procedure, the ciphering key CK_{CS} 24 and the integrity key IK_{CS} 26 are deleted. The GSM ciphering key K_{C} 28, however, is not deleted, and is used to perform ciphering while the UE 20 is camped within the GSM network 30. Assume that the UE 20 begins to move towards a Node B within the UTRAN 10. Based upon signal measurement reports sent by the UE 20, the GSM BSS decides to hand over the UE 20 to the UTRAN 10, which is performed by way of a HANDOVER TO UTRAN command sent to the UE 20 from the UTRAN 10 via the GSM network 30. According to section 8.3.6.3 of 3GPP TS 25.331, the UE 20 should apply ciphering immediately upon reception of the HANDOVER TO UTRAN command. However, CK_{CS} 24 and IK_{CS} 26 no longer exist within the USIM 20u, and consequently the UE 20 cannot perform ciphering. This can cause the software that implements the protocol stack to malfunction.

### SUMMARY OF INVENTION

It is therefore an objective of the claimed invention to provide a method and related device for handling security services when performing an Inter-RAT handover procedure.

Briefly summarized, the preferred embodiment of the claimed invention provides a method and associated wireless device that performs ciphering during an Inter Radio Access Technology (Inter-RAT) handover procedure. A HANDOVER FROM UTRAN procedure is performed to handover the wireless device from a Universal Mobile Telecommunications System (UMTS) Terrestrial Radio Access Network (UTRAN) to a second network. The second network is a non-UMTS network, such as a GSM network. While attached to the second network, the wireless device sends an INTER RAT HANDOVER INFO message to the UTRAN via the second network. The INTER RAT HANDOVER INFO message includes the security START value maintained by the wireless device for ciphering purposes. In response to receiving the security START value and determining that the security START value equals or exceeds the THRESHOLD value, the UTRAN disables ciphering with the wireless device when performing a HANDOVER TO UTRAN Inter-RAT procedure to handover the wireless device from the second network to the UTRAN. Similarly, the wireless device disables ciphering when performing the HANDOVER TO UTRAN procedure if the START value equals or exceeds the THRESHOLD value. Ciphering is disabled even though ciphering is active in the second network with the wireless device prior to performing the HANDOVER TO UTRAN procedure. After completing the HANDOVER TO UTRAN procedure, standard security service between the UTRAN and wireless device can be conventionally employed to generate a new key set and reactivate ciphering.

In a second embodiment, a HANDOVER FROM UTRAN procedure hands over the wireless device from the UTRAN to the second network. A conventional authentication and key agreement (AKA) procedure is performed, while the wireless device is attached to the second network, to provide the wireless device with a new key set. The AKA procedure is performed in response to the START value maintained by the wireless device being greater than or equal to the THRESHOLD value. After obtaining the new key set, the wireless device sets the START value to zero. Later, when a HANDOVER TO UTRAN procedure is performed, the wireless device utilizes the new key set to perform ciphering with the UTRAN during the HANDOVER TO UTRAN procedure.

It is an advantage of the claimed invention that by sending the START value to the UTRAN while the wireless device is attached to the second network, or alternatively by performing the AKA procedure, ciphering synchronization is maintained between the wireless device and the UTRAN. Communications thus continue uninterrupted during the Inter-RAT procedure.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 illustrates the use of an integrity algorithm f9 to authenticate data integrity of a signaling message.

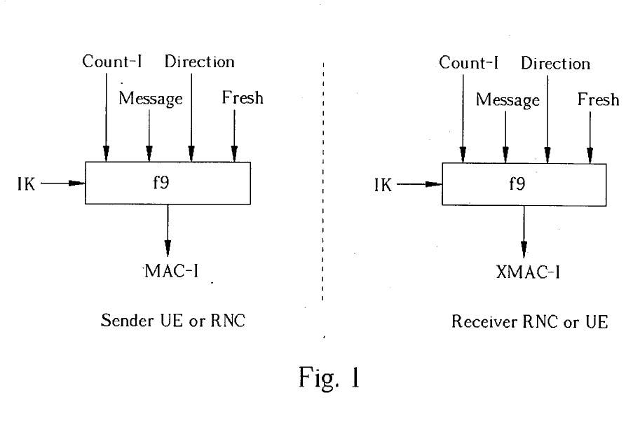

FIG. 2 is a block diagram of the data structure of a COUNT-I value depicted in FIG. 1.

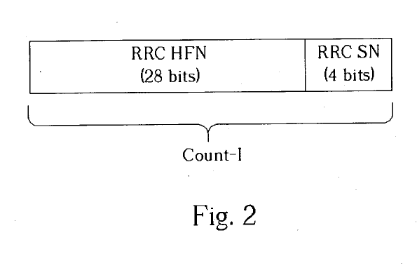

FIG. 3 illustrates ciphering of user and signalling data over a radio access link.

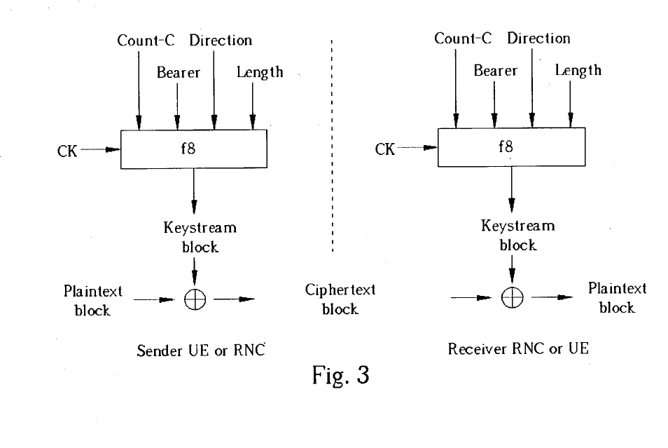

FIG. 4 is a block diagram of a COUNT-C value depicted in FIG. 3 for all connection modes.

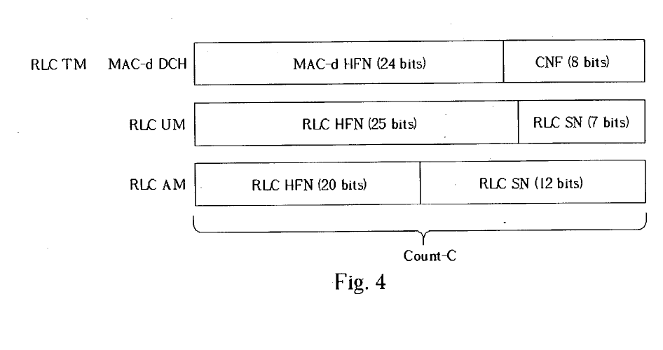

FIG. 5 is a simple block diagram of an Inter-RAT procedure.

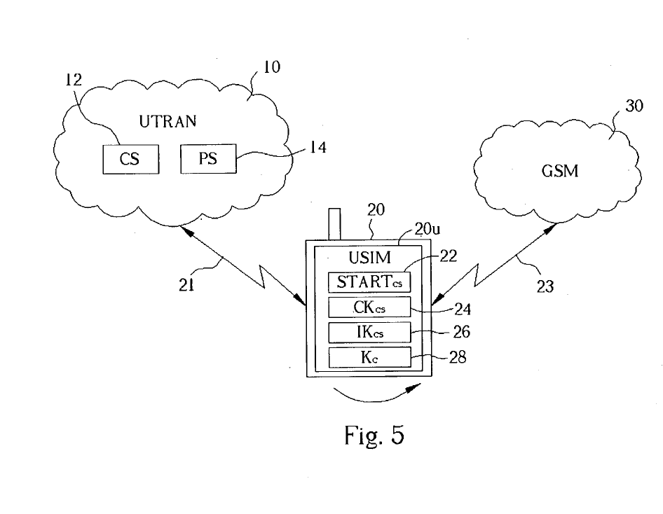

FIG. 6 is a simple block diagram of a wireless device according to a preferred embodiment of the present invention.

FIG. 7 is a message sequence chart for a first embodiment of the present invention.

FIG. 8 is a message sequence chart for a second embodiment of the present invention method.

FIG. 9 is a message sequence chart for a third embodiment of the present invention method.

### DETAILED DESCRIPTION

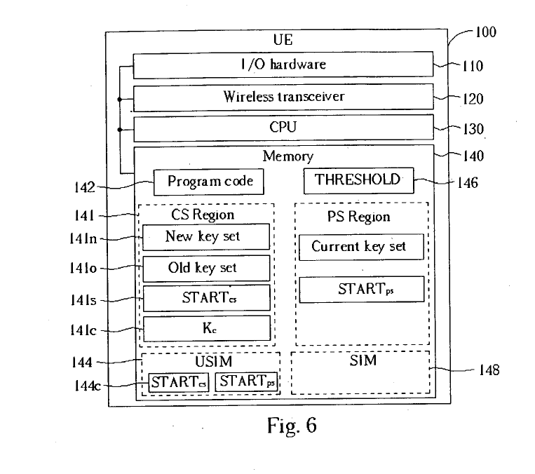

Please refer to FIG. 6. FIG. 6 is a simple block diagram of a wireless device 100 according to a preferred embodiment of the present invention. The wireless device 100 includes input/output (I/O) hardware 110, a wireless transceiver 120 and memory 140 that are all connected to and under the control of a central processing unit (CPU) 130 in a manner familiar to those of regular skill in the art. The I/O hardware 110 may include, for example, a display and speaker for output, and a keypad and microphone for input. The wireless transceiver 120 enables the wireless device 100 to send and receive wireless signals. The CPU 130 controls the functionality of the wireless device 100 according to program code 142 contained within the memory 140 and executable by the CPU 130. In most aspects the wireless device 100 is identical to that of the prior art, but for modifications made to the program code 142 to implement the present invention methods. How to effect such changes to the program code 142 should be clear to one of ordinary skill in the art after reading the following detailed description of the present invention methods.

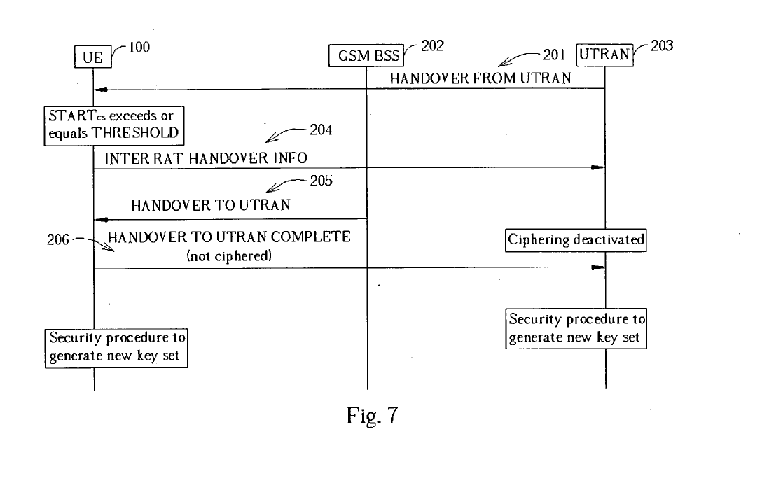

Please refer to FIG. 7 with reference to FIG. 6. FIG. 7 is a message sequence chart for a first embodiment of the present invention. As in the prior art, the present invention wireless device, the UE 100, is capable of performing a first Inter-RAT procedure so as to switch over from a 3GPP protocol to another protocol, such as GSM. To do this, the wireless device 100 first establishes a radio resource control (RRC) connection with the UTRAN 203. This RRC connection can be in the PS domain or the CS domain. For purposes of explanation of the following present invention methods and related wireless device 100, the CS domain is assumed, but the present invention methods may also be applicable to the PS domain. The wireless device 100 performs the first Inter-RAT procedure, such as an Inter-RAT handover procedure by way of a HANDOVER FROM UTRAN command 201, so that the UE 100 becomes attached to a second, non-UMTS system, such as a GSM BSS 202. When performing the HANDOVER FROM UTRAN command 201, ciphering is active between the UE 100 and the UTRAN 203, and hence to perform ciphering the UE 100 utilizes an old key set 1410 and an associated security START_{CS} value 141s in a conventional manner. Note that the old key set 1410 includes a cipher key CK_{CS} for the CS domain and an integrity key IK_{CS} for the CS domain. Because ciphering is to be performed between the UE 100 and the GSM BSS 202, the UE 100 generates a ciphering key K_{C} 141c in a standard manner from the old key set 141o. That is, K_{C}=f(CK_{CS}, IK_{CS}), where f( ) is a predetermined function that is known in the art. The function f( ) may also include other parameters, such as the current key set from the PS domain. In the first embodiment, it is assumed that when the HANDOVER FROM UTRAN command 201 is finished, the START_{CS} value 141s equals or exceeds a THRESHOLD value 146, which is a predetermined value that may be set by an operator or system designer, and which indicates that the key set has become old and so needs to be changed. Consequently, upon completing the HANDOVER FROM UTRAN command 201, the UE 100 deletes the old key set 141o. Nevertheless, the UE 100 has the GSM ciphering key K_{C} 141c, and so is able to continue ciphered communications with the GSM BSS 202. Before the UE 100 is handed back to the UTRAN 203, a conventional INTER RAT HANDOVER INFO message 204 is sent to the UTRAN 203 via the GSM BSS 202 in a standard manner, and includes the START_{CS} value 141s for ciphering synchronization at the next handover to UTRAN. Eventually, a second Inter-RAT procedure is performed to handover the UE 100 to the UTRAN 203. This second Inter-RAT procedure is performed with the GSM BSS 202 sending a HANDOVER TO UTRAN command 205 to the UE 100. Note that the HANDOVER TO UTRAN command 205 is ciphered byway of the ciphering key K_{C} 141c. The UE 100 processes the HANDOVER TO UTRAN command 205 in a standard manner, and responds by sending a HANDOVER TO UTRAN COMPLETE message 206 to the UTRAN 203. However, whereas ciphering is conventionally employed by the UE 100 when the HANDOVER TO UTRAN COMPLETE message 206 is sent, in this first embodiment method the UE 100 does not apply ciphering during the HANDOVER TO UTRAN response and acknowledgement procedure because the START_{CS} value 141s has exceeded (or equalled) the THRESHOLD value 146, and there is consequently no key set with which the UE 100 may perform ciphering. Similarly, because the UTRAN 203 received the START_{CS} value 141s via the INTER RAT HANDOVER INFO message 204, and thereby learns that the START_{CS} value equals or exceeds the THRESHOLD value 146, the UTRAN 203 disables ciphering as it awaits reception of the HANDOVER TO UTRAN COMPLETE message 206 from the UE 100. Ciphering is thus synchronized between the UE 100 and the UTRAN 203 during the second Inter-RAT handover procedure. Thereafter, the UE 100 and the UTRAN 203 may initiate a conventional security procedure to generate a new key set 141n and a new associated START_{CS} value 141s (which is typically zero), to reactivate ciphering.

The following methods of the present invention employ conventional authorization and key agreement (AKA) services to enable the UE 100 to obtain a new key set 141n while attached to the non-UTMS network. AKA procedures are conventional security challenge-and-response procedures between an AKA server, such as a Visitor Location Register (VLR), and the UE 100, which are used to generate key sets. The detailed operation of AKA procedures is beyond the scope of this invention, and can vary depending upon the security configuration of the UE 100 (for example, depending upon whether the UE 100 has a USIM 144 or not). Upon completion of an AKA procedure, the UE 100 will contain a new key set 141n, and further, the AKA procedure informs the UTRAN of the new key set 141n.

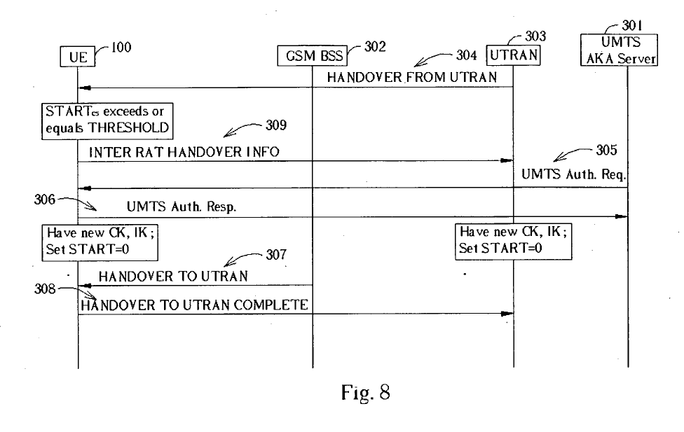

Please refer to FIG. 8. FIG. 8 is a message sequence chart for a second embodiment of the present invention method. For this second embodiment, it is assumed that the UE 100 contains a USIM 144, and so is capable of performing a UMTS AKA procedure with a UMTS AKA server 301. The UMTS AKA server 301 may be, for example, a VLR/SGSN. As in the first embodiment, a first Inter-RAT procedure, such as a HANDOVER FROM UTRAN procedure 304, occurs to attach the UE 100 onto a second, non-UMTS network, such as a GSM BSS 302. Upon completion of the HANDOVER FROM UTRAN command 304, START_{CS} 141s within the UE 100 equals or exceeds the THRESHOLD value 146, and so the old key set 1410 (which had been used up to that point to perform ciphering and to generate the GSM ciphering key K_{C} 141c) is discarded. Ciphering continues, though, between the UE 100 and the GSM BSS 302 by way of the GSM ciphering key K C 141c. Before handing back to the UTRAN 303, the UE 100 sends an INTER RAT HANDOVER INFO message 309 to the UTRAN 303 via the GSM BSS 302. Additionally, because the START_{CS} 141s has equalled or exceeded the THRESHOLD value 146, a UMTS AKA procedure is performed between the UE 100 and the UMTS AKA server 301 while the UE 100 is still attached to the second network, i.e., the GSM BSS 302. The UMTS AKA procedure may be initiated, for example, by the UTRAN 303 receiving the INTER RAT HANDOVER INFO message 309 and noting that START_{CS} is out of bounds, and thus instructing the UMTS AKA server 301 to perform a UMTS AKA procedure with the UE 100. The UMTS AKA server 301 sends a UMTS authorization request 305 to the UE 100, and the UE 100 responds with a UMTS authorization response 306. Upon completion of this challenge and response action, the UE 100 will have a new key set 141n. In response to having the new key set 141n, the UE 100 sets START 141s to a value that is less than the THRESHOLD value 146, and which is ideally zero, as this provides the maximum potential lifetime to the new key set 141n. Similarly, at the end of the successful UMTS AKA challenge-and-response session between the UE 100 and the UMTS AKA server 301, the UMTS AKA Server 301 informs the UTRAN 303 of the new key set 141n generated by the UE 100. Consequently, the UTRAN 303 sets its START_{CS} value to zero as well (i.e., to the same value that the UE 100 sets START_{CS} 141s). Eventually, a decision is made to handover the UE 100 back to the UTRAN 303. Consequently, a HANDOVER TO UTRAN command 307 is sent to the UE 100 by the GSM BSS 302. Upon reception of the HANDOVER TO UTRAN command 307, the UE 100 immediately applies ciphering with the new key set 141n and the new value of START_{CS} 141s. Consequently, when the UE 100 sends a HANDOVER TO UNTRAN COMPLETE message 308 to the UTRAN 303 to complete the second Inter-RAT procedure, ciphering is ongoing.

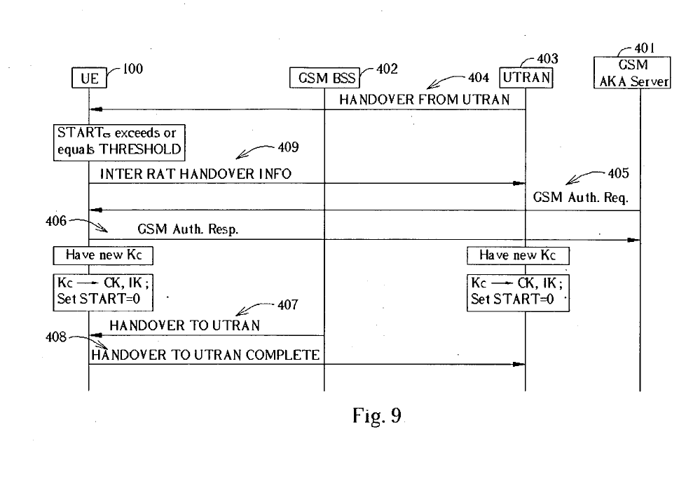

Please refer to FIG. 9. FIG. 9 is a message sequence chart for a third embodiment of the present invention method. For this third embodiment, it is assumed that the UE 100 does not contain a USIM 144, and so cannot perform a UMTS AKA procedure. Instead, the UE 100 contains a SIM 148, and so may perform a GSM AKA procedure with a GSM AKA server 401. As in the previous embodiments, a first Inter-RAT procedure, such as a HANDOVER FROM UTRAN procedure 404, occurs to attach the UE 100 onto a second, non-UMTS network, such as a GSM BSS 402. Upon completion of the HANDOVER FROM UTRAN command 404, START_{CS} 141s within the UE 100 equals or exceeds the THRESHOLD value 146, and so the old key set 141o is discarded. Ciphering continues between the UE 100 and the GSM BSS 402 by way of the GSM ciphering key K_{C} 141c. Before handing back to the UTRAN 403, the UE 100 sends an INTER RAT HANDOVER INFO message 409 to the UTRAN 403 via the GSM BSS 402. Additionally, because the START_{CS} 141s has equalled or exceeded the THRESHOLD value 146, a GSM AKA procedure is performed between the UE 100 and the GSM AKA server 401 while the UE 100 is still attached to the second network, i.e., the GSM BSS 402. The GSM AKA procedure may be initiated, for example, by the UTRAN 403, or the GSM BSS 402, receiving the INTER RAT HANDOVER INFO message 409 and noting that START_{CS} is out of bounds, and thus instructing the GSM AKA server 401 to perform the GSM AKA procedure with the UE 100. The GSM AKA server 401 sends a GSM authorization request 405 to the UE 100, and the UE 100 responds with a GSM authorization response 406. Upon completion of this challenge and response action, the UE 100 will have a new ciphering key K_{C}. This new ciphering key K may or may not be used to perform ciphering between the UE 100 and the GSM BSS 402. In response to having the new ciphering key K_{C}, the UE 100 generates a new key set 141n from the new ciphering key K_{C} using a predefined function that is known in the art. That is, new key set=F(new K_{C}). Upon obtaining the new key set 141n, the UE 100 sets START_{CS} 141s to a value that is less than the THRESHOLD value 146, and which is ideally zero. The UTRAN 403 is made aware of the new GSM ciphering key K_{C} and similarly generates a new key set that matches that of the UE 100. Consequently, the UTRAN 403 sets its START value to zero as well. When a HANDOVER TO UTRAN command 407 is sent to the UE 100 by the GSM BSS 402, the UE 100 immediately applies ciphering with the new key set 141n and the new value of START_{CS} 141s. Thus, when the UE 100 sends a HANDOVER TO UNTRAN COMPLETE message 408 to the UTRAN 403 to complete the second Inter-RAT procedure, ciphering is ongoing.

Although specific examples of the present invention have been described with reference to GSM systems, it should be noted that the present invention may also be used with other radio access technologies (RATs).

In contrast to the prior art, the present invention provides for ciphering synchronization between the UE and the UTRAN when handing over from a second RAT back to the UTRAN. Ciphering may be turned off during the handover procedure if the old key set was discarded, or a ciphering may be activated during the handover if a new key set was obtained while the UE was attached to the second RAT system.

Those skilled in the art will readily observe that numerous modifications and alterations of the method may be made while retaining the teachings of the invention. Accordingly, the above disclosure should be construed as limited only by the metes and bounds of the appended claims.

What is claimed is:

1. A method for performing ciphering during an Inter Radio Access Technology (Inter-RAT) handover procedure, the method comprising:
performing a first Inter-RAT procedure to handover a wireless device from a Universal Mobile Telecommunications System (UMTS) Terrestrial Radio Access Network (UTRAN) to a second network;
the wireless device sending a first message to the UTRAN via the second network, the first message including a security START value maintained by the wireless device; and
in response to receiving the security START value and determining that the security START value equals or exceeds a THRESHOLD value, the UTRAN disabling ciphering with the wireless device when performing a second Inter-RAT procedure to handover the wireless device from the second network to the UTRAN;
wherein ciphering is active in the second network with the wireless device prior to performing the second Inter-RAT procedure.

2. The method of claim 1 wherein the second network is a non-UMTS network.

3. The method of claim 2 wherein the second network is a Global System for Mobile Communications (GSM) network.

4. The method of claim 1 wherein the first message is an INTER RAT HANDOVER INFO message.

5. The method of claim 1 further comprising:
in response to the security START value equaling or exceeding the THRESHOLD value, the wireless device disabling ciphering with the UTRAN during the second Inter-RAT procedure.

6. The method of claim 1 further comprising:
the wireless device performing an authentication and key agreement (AKA) procedure, and performing a security procedure with the UTRAN to obtain a new security key set in response to successfully completing the second Inter-RAT procedure; and
the wireless device utilizing the new security key set to initiate ciphering with the UTRAN.

7. A wireless device for implementing the method of claim 1.

8. A wireless device comprising a processor and memory, the memory containing program code executable by the processor for performing the following steps:
performing a first Inter-RAT procedure to handover the wireless device from a Universal Mobile Telecommunications System (UMTS) Terrestrial Radio Access Network (UTRAN) to a second network;
sending a first message to the UTRAN via the second network, the first message including a security START value maintained by the wireless device; and
in response to the security START value equaling or exceeding a THRESHOLD value, disabling ciphering with the UTRAN during a second Inter-RAT procedure to handover the wireless device from the second network to the UTRAN;
wherein ciphering is active in the second network with the wireless device prior to performing the second Inter-RAT procedure.

9. The wireless device of claim 8 wherein the second network is a non-UMTS network.

10. The wireless device of claim 9 wherein the second network is a Global System for Mobile Communications (GSM) network.

11. The wireless device of claim 8 wherein the first message is an INTER RAT HANDOVER INFO message.

12. The wireless device of claim 1 wherein the program code further performs the following steps:
performing an authentication and key agreement (AKA) procedure, and
performing a security procedure with the UTRAN to obtain a new security key set in response to successfully completing the second Inter-RAT procedure; and
utilizing the new security key set to initiate ciphering with the UTRAN.

13. A method for performing ciphering during an Inter Radio Access Technology (Inter-RAT) handover procedure, the method comprising:
performing a first Inter-RAT procedure to handover a wireless device from a Universal Mobile Telecommunications System (UMTS) Terrestrial Radio Access Network (UTRAN) to a second network;
performing an authentication and key agreement (AKA) procedure to provide the wireless device a new key set in response to a START value maintained by the wireless device being greater than or equal to a THRESHOLD value;
in response to the wireless device obtaining the new key set, setting the START value to a predetermined value that is less than the THRESHOLD value; and
performing a second Inter-RAT procedure to handover the wireless device from the second network to the UTRAN;
wherein the wireless device utilizes the new key set to perform ciphering with the UTRAN during the second Inter-RAT procedure.

14. The method of claim 13 wherein the predetermined value is zero.

15. The method of claim 13 further comprising:
the wireless device sending a first message to the UTRAN via the second network, the first message including the security START value maintained by the wireless device.

16. The method of claim 15 wherein the first message is an INTER RAT HANDOVER INFO message.

17. The method of claim 13 wherein the second network is a non-UMTS network.

18. The method of claim 17 wherein the second network is a Global System for Mobile Communications (GSM) network.

19. The method of claim 17 wherein the AKA procedure provides a key K_{C}, and the method further comprises generating the new key set from the key K_{C}.

20. A wireless device for performing the method of claim 13.

21. A wireless device comprising a processor and memory, the memory containing program code executable by the processor for performing the following steps:
performing a first Inter-RAT procedure to handover the wireless device from a Universal Mobile Telecommunications System (UMTS) Terrestrial Radio Access Network (UTRAN) to a second network;
performing an authentication and key agreement (AKA) procedure to provide the wireless device a new key set;
in response to the wireless device obtaining the new key set while attached to the second network, setting a security START value associated with the new key set to a predetermined value that is less than a THRESHOLD value; and
performing a second Inter-RAT procedure to handover the wireless device from the second network to the UTRAN;
wherein the wireless device utilizes the new key set to perform ciphering with the UTRAN during the second Inter-RAT procedure.

22. The wireless device of claim 21 wherein the predetermined value is zero.

23. The wireless device of claim 21 wherein the program code further performs the following step:
sending a first message to the UTRAN via the second network, the first message including the security START value maintained by the wireless device.

24. The wireless device of claim 23 wherein the first message is an INTER RAT HANDOVER INFO message.

25. The wireless device of claim 21 wherein the second network is a non-UMTS network.

26. The wireless device of claim 25 wherein the second network is a Global System for Mobile Communications (GSM) network.

27. The wireless device of claim 25 wherein the AKA procedure provides a key K_{C} and the program code further comprises the step of generating the new key set from the key K_{C}.
